(19) United States
(12) Patent Application Publication
(10) Pub. No.: US 2024/0332861 A1
(43) Pub. Date: Oct. 3, 2024

(54) PLUG CONNECTOR

(71) Applicant: ENOVA Solutions AG, Chur (CH)

(72) Inventor: Werner BACHMANN, Rankweil (AT)

(21) Appl. No.: 18/737,355

(22) Filed: Jun. 7, 2024

Related U.S. Application Data
(63) Continuation of application No. PCT/EP2022/081376, filed on Nov. 10, 2022.

(30) Foreign Application Priority Data
Dec. 10, 2021 (AT) A 50990/2021

(51) Int. Cl. H01R 13/58; H01R 13/52; H01R 43/20

(52) U.S. Cl. CPC H01R 13/5845; H01R 13/5205; H01R 43/20

(57) ABSTRACT

A method for producing a preassembled cable having at least one electrical plug connector includes: inserting a free end of a cable through a sleeve part of the plug connector, connecting a signal conductor at the free end of the cable to an electrical contact of a contact carrier of the plug connector, introducing the connected contact carrier into the sleeve part, located on the cable, of the plug connector, introducing an insert into the sleeve part of the plug connector for relieving strain on the cable and for sealing off the sleeve part of the plug connector at the cable end, and encapsulating by injection-moulding at least a portion of the sleeve part of the plug connector with injection-moulding material.

The present invention is a continuation of International Application PCT/EP2022/081376 filed on Nov. 10, 2022. Thus, all of the subject matter of International Application PCT/EP2022/081376 is incorporated herein by reference.

### BACKGROUND OF THE INVENTION

The invention relates to a method for producing a preassembled cable with at least one electrical plug connector, an electrical plug connector and a preassembled cable with at least one plug connector.

Electrical plug connectors known in the state of the art are usually constructed in several parts and normally have a contact which can be connected to a signal conductor of a cable and which can be screwed or clamped in a housing part of the plug connector that is usually formed sleeve-like. In order to guarantee a strain relief between the contact and the cable while the plug connector is in use, plug connectors known in the state of the art have strain reliefs, for example in the form of collets, acting between the cable and the housing. Furthermore, it is known in the state of the art to seal the housing of plug connectors, for example in order to protect the connection points, usually located in the housing, between the at least one contact and the signal conductor from environmental influences such as wetness or moisture. Solutions known in the state of the art comprise plug connectors with sealing cable grommets, which can be screwed to housing parts of the plug connector. The production of a preassembled cable with such an electrical plug connector proves to be time-consuming, as special rubber or plastic grommets are needed to fit sealing parts of the plug connector on the cable.

### SUMMARY OF THE INVENTION

The object of the invention is to specify a method for producing a preassembled cable with at least one electrical plug connector that is improved compared with the state of the art, an improved electrical plug connector and an improved preassembled cable with at least one plug connector.

A preassembled cable can generally have a cable with at least one electrically conducting signal conductor and at least one electrical plug connector. A cable can be present for example in the form of a two-pole or multi-pole cable. The cable can also have an electrically conductive shield. In particular, the cable can be designed in the form of a two-to multi-pole cable. The signal conductors can be electrically insulated. The cable can have an insulating sheath for the mechanical protection of the signal conductors.

The plug connector can be formed, for example, as a circular plug connector, barrel plug, Molex plug connector, ATX plug connector, SATA plug connector, USB plug connector, on-board voltage plug in the automotive sector, mains plug, laboratory plug connector such as a banana plug, crocodile clip, coaxial plug connector, Cinch plug connector, DIN plug connector, mini-DIN plug connector, speaker plug, measuring device plug, jack plug, XLR plug connector, D-sub plug connector, BNC plug connector, N plug connector, SMA plug connector, SMB plug connector, SMC plug connector, SMP plug connector, SMS plug connector, TNC plug connector, MCX plug connector, MMCX plug connector, SCART plug connector, Belling-Lee plug connector, F plug connector, HDMI plug connector, HD-SDI plug connector, RJ45 plug connector, Ethernet plug connector, IEC bus plug connector, ISDN plug connector, general charging plug for electric vehicles, type 1 plug connector, type 2 plug connector, CCS plug connector or CHAdeMO plug connector.

The plug connector can be formed as a male part, in particular with outwardly pointing contacts, as a female part, in particular with inwardly pointing contacts or contact openings, or as a hybrid.

The electrical plug connector can generally have a housing with a or in the form of a sleeve part. In an assembled state of the plug connector, the sleeve part can receive and at least partially envelop contacts of the plug connector and the cable at least partially in an inner area of the sleeve part.

For connecting at least one signal conductor of the cable, the plug connector can have a contact carrier with at least one electrical contact. The contact carrier can make it possible to position the contact in the sleeve part and can electrically insulate the at least one contact from the sleeve part. The contact carrier can in particular be formed of an electrically insulating material and can receive the at least one contact at least partially in an inner area of the body of the contact carrier.

The sleeve part can have at least one contact-side axial opening and a cable-side axial opening.

For fastening the cable on the sleeve part—and thus for strain relief between the contact and the cable—the plug connector can have at least one insert.

A sealing of an opening of the plug connector can generally refer to a gas- or liquid-tight closure of an opening.

The method according to the invention serves for the production of a preassembled cable with at least one electrical plug connector. By this can be meant in principle the production of a cable ready for connection at least on one side.

In a first method step, a free end of the cable can be pushed through a sleeve part of the plug connector. The free end of the cable can have signal conductors already bared, in particular stripped, for connection. As an alternative or in combination, the signal conductors can also be bared after the free end of the cable has been pushed through the sleeve part.

After that, at least one signal conductor at the free end of the cable can be connected to at least one electrical contact of a contact carrier of the plug connector. A connection can be effected for example by soldering, crimping or clamping.

This sequence of pushing through and connecting can be suitable for long cable lengths, for example if the cable is unwound from a drum. This sequence is also suitable if a plug connector is already attached to the other end of the preassembled cable.

If the cable has two free ends, at least one signal conductor at one free end of the cable can also be connected to at least one electrical contact of a contact carrier of the plug connector before the other free end of the cable is pushed through a sleeve part of the plug connector.

In a further method step the connected contact carrier can be inserted into the sleeve part of the plug connector located on the cable.

An insertion of the connected contact carrier into the sleeve part located on the cable can be effected by pressing or screwing the contact carrier in.

During the insertion of the contact carrier, a friction and/or positive locking between the contact carrier and the sleeve part can be effected.

A sealing of the contact-side axial opening of the sleeve part can advantageously be effected through the insertion of the connected contact carrier into the sleeve part of the plug connector located on the cable.

The contact carrier can for example be made of plastic and can be deformed during the insertion.

In a further method step an insert can be inserted into the sleeve part of the plug connector for strain relief of the cable and for sealing the sleeve part of the plug connector on the cable side.

The insert can be inserted axially into the cable-side axial opening of the sleeve part. As an alternative or in combination, the sleeve part can have a radial opening and an insertion of the insert can be effected radially, thus substantially transverse to the direction in which the free end of the cable is pushed through the sleeve part of the plug connector.

An insertion of the insert into the sleeve part of the plug connector can be effected by pressing or screwing the insert in.

During the insertion of the insert, a friction and/or positive locking between the insert and the sleeve part can be effected.

The insert can for example be made of plastic and can be deformed during the insertion.

A mechanical fixing of the cable on the sleeve part, for example by friction locking, can be effected through the insertion of the insert, which can result in a strain relief between the contact and the cable.

A sealing of the cable-side axial opening of the sleeve part with respect to the cable and/or the signal conductor can be effected through the insertion of the insert.

A sealing of the radial opening of the sleeve part can be effected through the insertion of the insert.

In a further method step at least a part of the sleeve part of the plug connector can be overmolded with injection-molding material.

The injection-molding material can be prevented from penetrating into an inner area of the sleeve part by a sealing of the cable-side opening and optionally the radial opening of the sleeve part due to the sealing insert.

An inner area of the sleeve part, and thus of the plug connector, can thus be kept free of injection-molding material. Connections to the at least one contact and movable mechanical parts, such as for instance a locking mechanism of a coupling of the plug connector, can thus be kept free of injection-molding material.

At least an overmolding of at least a part of the sleeve part, at least the area of the cable-side opening, and optionally the radial opening of the sleeve part, and a part of the cable emerging from the cable-side opening of the sleeve part can be effected.

The injection-molding material can contribute to the strain relief. Further, the injection-molding material can contribute to the kink protection of the preassembled cable.

Through the at least partial overmolding of the sleeve part, the injection-molding material can form a grip of the plug connector, in particular an electrically insulating grip.

The sleeve part can advantageously have protrusions, which project at least in sections from the sleeve part and which are embedded in the injection-molding material in the case of the overmolding of at least a part of the sleeve part. The injection-molding material can thus be anchored in a positive-locking manner to the sleeve part, in addition to any friction locking.

Protection is also sought for an electrical plug connector for a preassembled cable.

The electrical plug connector can, as previously described, have a sleeve part for a free end of a cable to be pushed through, at least one contact carrier with at least one electrical contact for connection of at least one signal conductor at a free end of the cable and at least one insert for fixing the cable on the sleeve part for strain relief. The sleeve part can have at least one contact-side axial opening and a cable-side axial opening.

The contact-side opening of the sleeve part can advantageously be sealable by insertion, in particular by screwing or pressing, of the at least one contact carrier into the contact-side opening of the sleeve part.

The cable-side opening of the sleeve part can advantageously be sealable by insertion, in particular by screwing or pressing in, of the at least one insert. The insert can additionally contribute to the strain relief by fixing the cable on the sleeve part.

The opening cross section of the axial cable-side opening can be able to be reduced substantially to a diameter of the cable due to the insert. Depending on the pressing-in depth, a sealing of the cable-side opening can be effected for different cable diameters. A sealing can thus be effected substantially independently of the diameter of the cable.

In an advantageous embodiment, the sleeve part has a radial opening, into which the insert can be inserted, in particular pressed or screwed, to seal the cable-side opening of the sleeve part. The insert can also seal the radial opening of the sleeve part.

The radial opening can be arranged in an end area of the sleeve part neighboring the axial cable-side opening.

The sleeve part of the plug connector can advantageously be overmolded at least partially with injection-molding material. At least an overmolding of at least a part of the sleeve part, at least the area of the cable-side opening, and optionally the radial opening of the sleeve part, and a part of the cable emerging from the cable-side opening of the sleeve part can be effected.

The sleeve part can have at least one protrusion, which projects at least in sections from the sleeve part and which, in the case of an overmolding of the sleeve part with injection-molding material, can be embedded in the injection-molding material.

The protrusion or protrusions can be formed by bars projecting at least in sections from the circumference of the sleeve part.

In particular, the radially projecting protrusion or protrusions can be formed undercut. The undercut can be formed contrary to the pulling direction of a cable on the plug connector for improved anchoring in the injection-molding material.

The sleeve part can advantageously be made of an electrically insulating material, for example of plastic, or an electrically conductive material, preferably of metal.

Protection is also sought for a preassembled cable with at least one electrical plug connector as described previously.

### BRIEF DESCRIPTION OF THE DRAWINGS

Embodiments of the invention are discussed with reference to the figures, in which:

FIGS. 1a to 1d provide a schematic sequence of an embodiment of a method for producing a preassembled cable;

FIGS. 2a and 2b are perspective views of an embodiment of a sleeve part 4;

FIGS. 3a to 3c are top views and a sectional representation of a sleeve part according to the embodiment of FIGS. 2a and 2b;

FIGS. 4a to 4d are top views and sectional representations of two preassembled cables connected to each other; and

FIG. 5 is a sectional representation of a plug connector, overmolded with injection-molding material, of a preassembled cable in an injection mold.

### DETAILED DESCRIPTION OF THE INVENTION

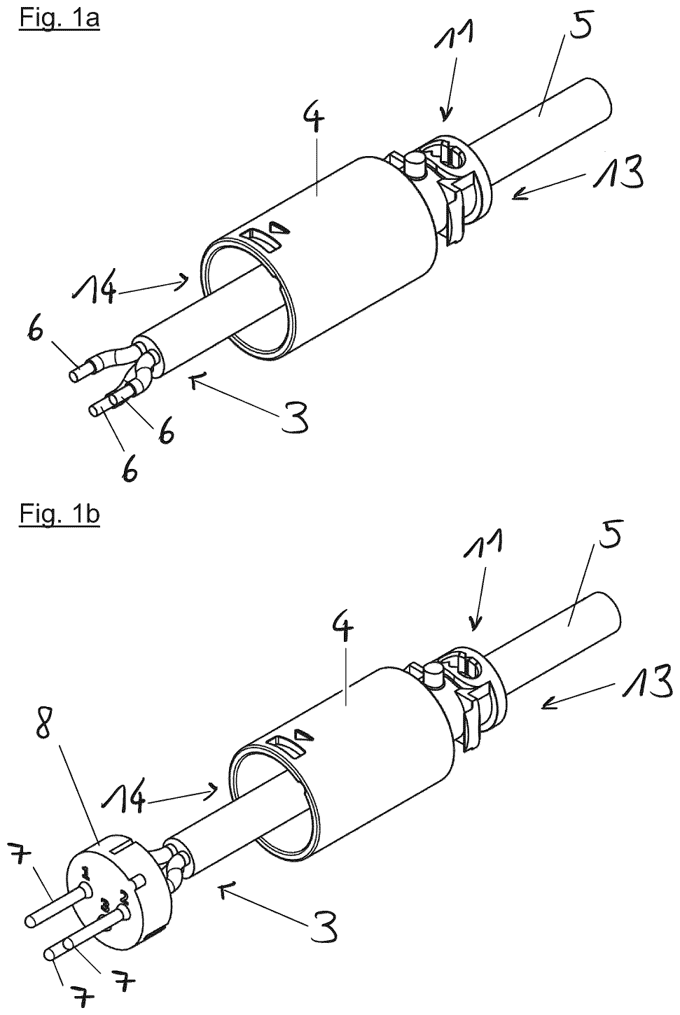

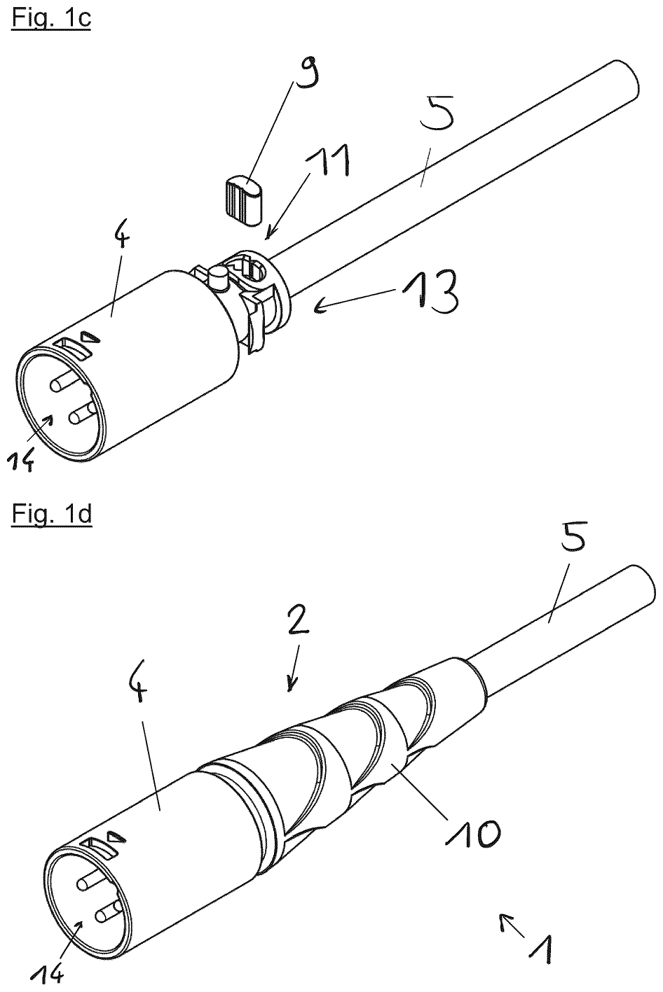

An example embodiment of a method for producing a preassembled cable 1 with at least one electrical plug connector 2 is represented in FIGS. 1a to 1d. In the embodiment shown by way of example, the plug connector 2 is formed as a circular plug connector in the form of an XLR plug.

FIG. 1a shows a pushing of a free end 3 of the cable 5 through from a cable-side axial opening 13 to a contact-side axial opening 14 of the sleeve part 4 of the plug connector 2. The sleeve part 4 is located on the cable 5 after the pushing through. At the free end 3 the cable 5 has bared and stripped signal conductors 6.

A connection of the signal conductors 6 at the free end 3 of the cable 5 to the electrical contacts 7 of the contact carrier 8 of the plug connector 2 has been effected in FIG. 1b.

An insertion of the connected contact carrier 8 into the sleeve part 4 of the plug connector 2 located on the cable 5 has been effected in FIG. 1c. The contact carrier 8 can have been pressed into the contact-side axial opening 14 of the sleeve part 4 contrary to the direction in which the cable 5 is pushed through. An insertion of an insert 9 into the sleeve part 4 of the plug connector 2 is provided to seal the cable-side opening 13, and also the radial opening 11. An insertion of the insert 9 substantially transverse to the direction in which the cable 5 is pushed through is effected in the embodiment of the sleeve part 4 shown.

A part of a fully preassembled cable 1 with a plug connector 2 is shown in FIG. 1d, wherein the plug connector 2 has a sleeve part 4 partially overmolded with injection-molding material 10.

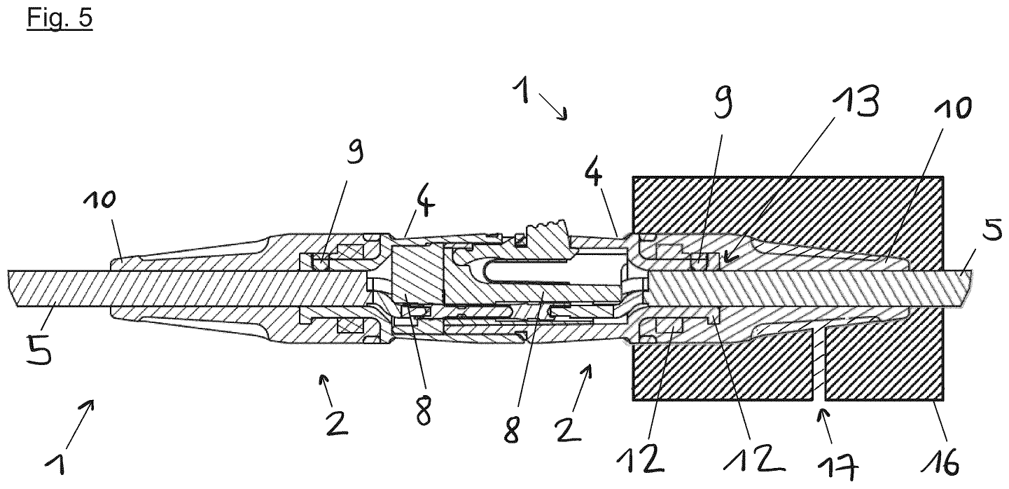

A sectional representation of an overmolded plug connector 2 in a corresponding injection mold is shown in FIG. 5.

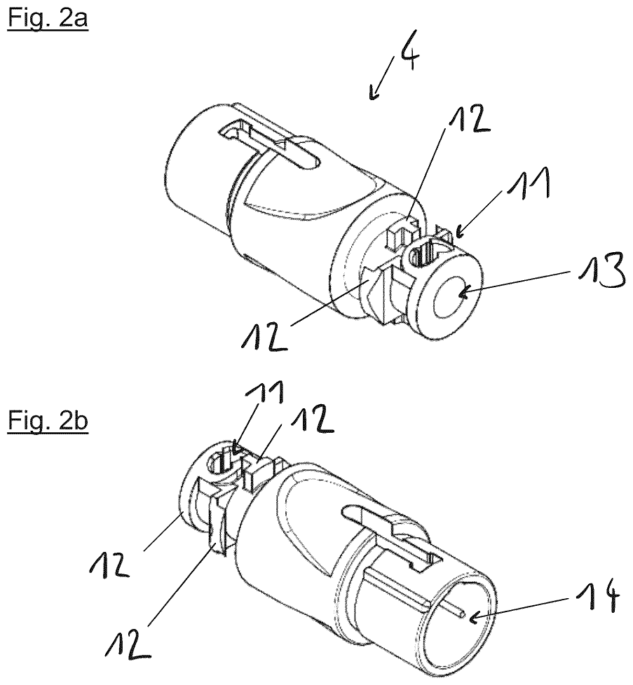

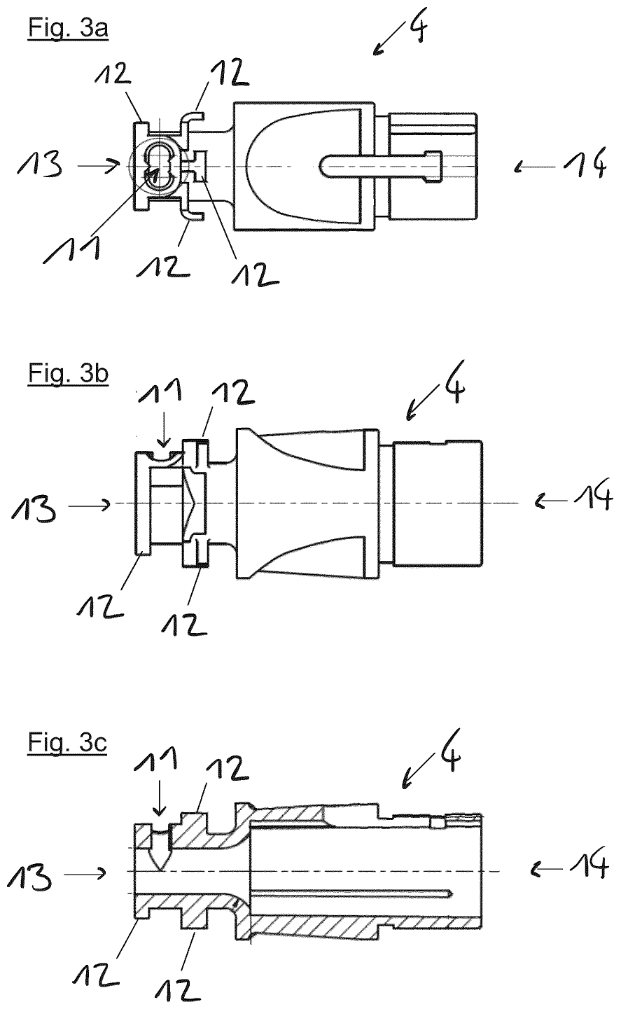

FIGS. 2a and 2b show perspective views of an embodiment of a sleeve part 4. FIGS. 3a and 3b show top views of this embodiment of the sleeve part 4. FIG. 3c shows a sectional representation of the view from FIG. 3b.

The sleeve part 4, as represented, has a cable-side axial opening 13, a contact-side axial opening 14 and a radial opening 11 arranged neighboring the cable-side opening 13. An insert 9 can be inserted into the opening 11 transverse to the direction, running from the cable-side axial opening 13 to the contact-side axial opening 14, in which a cable 5 is pushed through. An opening cross section of the cable-side axial opening 13 can be reduced, wherein a sealing of the cable-side axial opening 13 can be effected.

The sleeve part 4 has protrusions 12, which project from the sleeve part 4 and which, in the case of an overmolding of the sleeve part 4 with injection-molding material 10, can be embedded in the injection-molding material 10. The protrusions 12 can, as represented, be formed by at least one bar projecting at least in sections from the circumference of the sleeve part 4. The protrusions 12 can also be formed undercut.

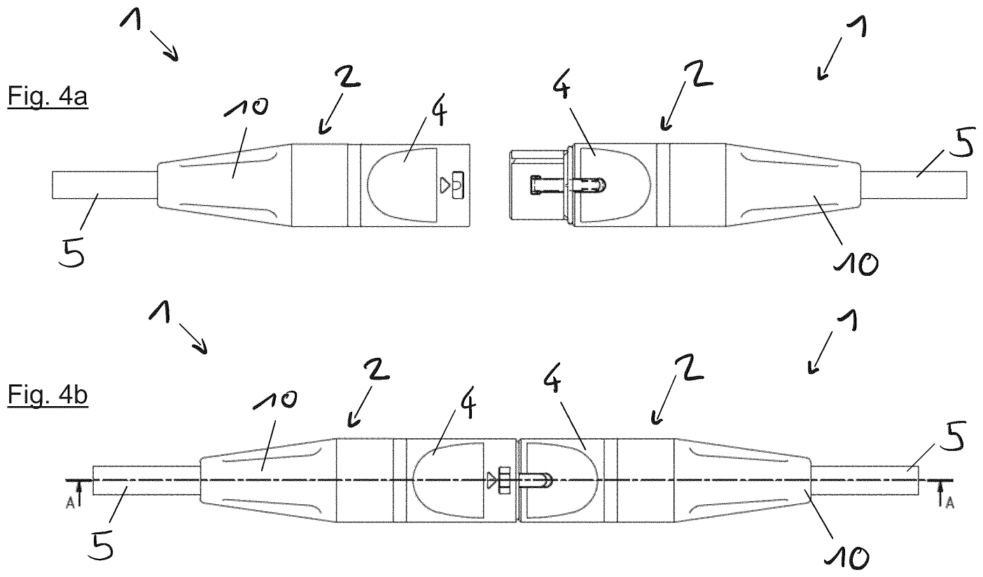

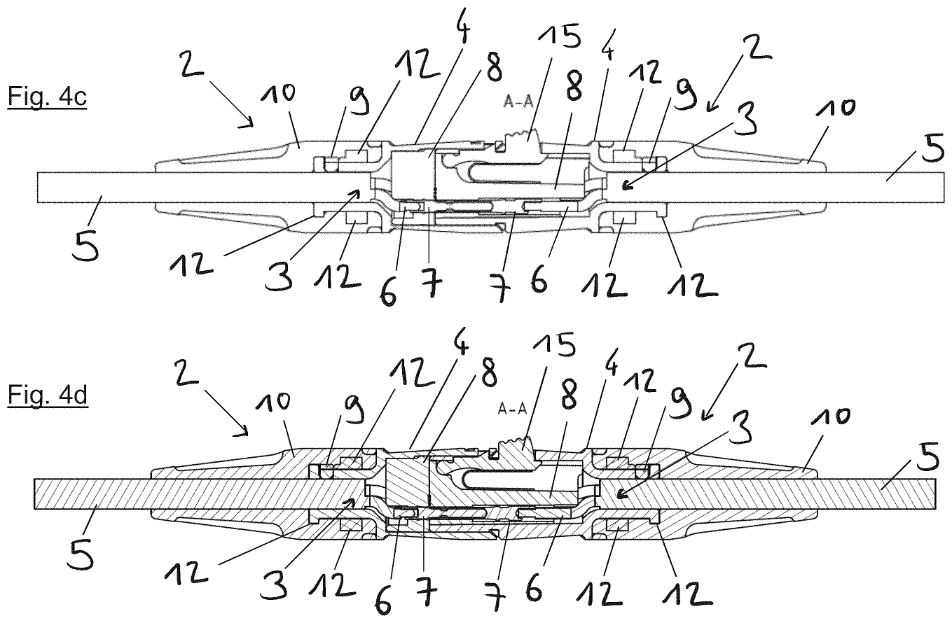

FIGS. 4a and 4b show a top view of sections of two preassembled cables 1, able to be coupled to each other, with plug connectors 2, which are formed as circular plug connectors in the form of XLR plug connectors by way of example. FIGS. 4c and 4d each show a sectional representation along the line A-A of FIG. 4b, wherein FIGS. 4c and 4d differ in the representation of the hatching of the component parts for the sake of better visibility of details.

It can be seen in FIGS. 4a to 4d that the electrical plug connector 2 for a preassembled cable 1 can in principle be formed as a male or female plug connector. Embodiments of the plug connector 2 as a hybrid are not to be ruled out.

It can be seen in particular in the sectional representations of FIGS. 4b and 4c that the plug connector 2 can have a sleeve part 4 for a free end 3 of a cable 5 to be pushed through, at least one contact carrier 8 with at least one electrical contact 7 for connection of at least one signal conductor 6 at the free end 3 of the cable 5 and at least one insert 9 for fixing the cable 5 on the sleeve part 4 for strain relief and for sealing the cable-side axial opening 13. In the embodiment shown, the sleeve part 4 has a radial opening 11, into which the insert 9 can be inserted to seal the cable-side opening 13 of the sleeve part 4.

FIG. 5 shows a sectional representation, analogous to FIG. 4d, of a plug connector 2, overmolded with injection-molding material, of a preassembled cable 1 in an injection mold 16. The injection mold 16 has a runner 17 for the injection of injection-molding material 10.

During the production of a preassembled cable 1, a plug connector 2, partially fitted analogously to FIG. 1c, with an inserted insert 9 can be arranged in an injection mold 16 and, as represented, at least a part of the sleeve part 4 of the plug connector 2 can be overmolded with injection-molding material 10.

It can be seen that an overmolding of at least a part of the sleeve part 4, at least the area of the cable-side axial opening 13 of the sleeve part 4, the radial opening 11 of the sleeve part 4 and a part of the cable 5 emerging from the cable-side opening 13 of the sleeve part 4 can be effected.

Injection-molding material 10 can be prevented from penetrating an inner area of the sleeve part 4 through the cable-side opening 13 and the radial opening 11 due to the sealing via the insert 9. Connections to the contacts 7 and movable mechanical parts, such as for instance a locking mechanism 15 of a coupling of the plug connector 2, can thus be kept free of injection-molding material 10.

### LIST OF REFERENCE NUMBERS

1 preassembled cable
2 plug connector
3 free end
4 sleeve part
5 cable
6 signal conductor
7 electrical contact
8 contact carrier
9 insert
10 injection-molding material
11 radial opening
12 protrusion
13 cable-side axial opening
14 contact-side axial opening
15 locking mechanism of coupling
16 injection mold
17 runner

1. A method for producing a preassembled cable with at least one electrical plug connector, in particular at least one XLR plug connector, comprising the following method steps:
pushing a free end of a cable through a sleeve part of the plug connector,
connecting at least one signal conductor at the free end of the cable to at least one electrical contact of a contact carrier of the plug connector,
inserting the connected contact carrier into the sleeve part of the plug connector located on the cable,
inserting an insert into the sleeve part of the plug connector for strain relief of the cable and for sealing the sleeve part of the plug connector on the cable side,
overmolding at least a part of the sleeve part of the plug connector with injection-molding material.

2. The method according to claim 1, wherein an insertion of the connected contact carrier into the sleeve part located on the cable is effected by pressing or screwing the contact carrier in.

3. The method according to claim 1, wherein the sleeve part has a radial opening and an insertion of the insert is effected substantially transverse to the direction in which the free end of the cable is pushed through the sleeve part of the plug connector.

4. The method according to claim 1, wherein an insertion of the insert into the sleeve part of the plug connector is effected by pressing or screwing the insert in.

5. The method according to claim 1, wherein the sleeve part has at least one protrusion projecting at least in sections from the sleeve part and, in the case of the overmolding of at least a part of the sleeve part of the plug connector with injection-molding material, an embedding of the at least one protrusion in the injection-molding material is effected.

6. The method according to claim 1, wherein at least an overmolding of at least a part of the sleeve part, at least the area of a cable-side axial opening of the sleeve part, and optionally the radial opening of the sleeve part, and a part of the cable emerging from the cable-side opening of the sleeve part is effected.

7. An electrical plug connector for a preassembled cable with a sleeve part for a free end of a cable to be pushed through, at least one contact carrier with at least one electrical contact for connection of at least one signal conductor at the free end of the cable and at least one insert for fixing the cable on the sleeve part for strain relief, wherein the sleeve part has at least one 20 cable-side axial opening,
wherein the cable-side opening of the sleeve part can be sealed through the insertion of the at least one insert.

8. The electrical plug connector according to claim 7, wherein the sleeve part has a radial opening, into which the insert can be inserted to seal the cable-side opening of the sleeve part.

9. The electrical plug connector according to claim 7, wherein the sleeve part is at least partially overmolded with injection-molding material.

10. The electrical plug connector according to claim 9, wherein at least a part of the sleeve part, at least the area of the cable-side opening, and optionally the radial opening of the sleeve part, and a part of the cable emerging from the cable-side opening of the sleeve part is overmolded.

11. The electrical plug connector according to claim 9, wherein the sleeve part has at least one protrusion, which projects at least in sections from the sleeve part and which, in the case of an overmolding of the sleeve part with injection-molding material, can be embedded in the injection-molding material.

12. The electrical plug connector according to claim 1, wherein the at least one protrusion is formed by at least one bar projecting at least in sections from the circumference of the sleeve part and/or the at least one protrusion is formed undercut.

13. The electrical plug connector according to claim 7, wherein the sleeve part is made of an electrically conductive material, preferably of metal.

14. A preassembled cable with at least one electrical plug connector according to claim 7.
